(19) United States
(12) Patent Application Publication
(10) Pub. No.: US 2026/0058275 A1
(43) Pub. Date: Feb. 26, 2026

(54) BATTERY PACK ENCLOSURE HAVING A MULTILAYER STRUCTURE

(71) Applicant: Ford Global Technologies, LLC, Dearborn, MI (US)

(72) Inventors: Patrick Roxin, Livonia, MI (US); Bhaskara Rao Boddakayala, Troy, MI (US); Druva Krishnaswami, Detroit, MI (US); Derek Langley, Dearborn, MI (US)

(21) Appl. No.: 18/812,403

(22) Filed: Aug. 22, 2024

(51) Int. Cl. H01M 50/231; B60L 50/64; H01M 10/658; H01M 50/211; H01M 50/224; H01M 50/227; H01M 50/229; H01M 50/271; H01M 50/289

(52) U.S. Cl. CPC H01M 50/231; B60L 50/64; H01M 10/658; H01M 50/211; H01M 50/224; H01M 50/227; H01M 50/229; H01M 50/271; H01M 50/289; H01M 2220/20

(57) ABSTRACT

A traction battery pack assembly includes an enclosure assembly configured to house a plurality of battery cells within an interior area. The enclosure assembly is at least partially provided by a multilayer structure having an apertured core with one or more layers sandwiched between an outer shell and an inner shell. The apertured core has a plurality of apertures. The multilayer structure is at least partially impregnated with a resin.

### TECHNICAL FIELD

This disclosure relates generally an enclosure of a traction battery pack and, more particularly, to an enclosure having a multilayer structure.

### BACKGROUND

Electrified vehicles differ from conventional motor vehicles because electrified vehicles can be selectively driven by one or more electric machines that are powered by one or more battery cells of a traction battery pack. The electric machines can propel the electrified vehicles instead of, or in combination with, an internal combustion engine.

The traction battery pack can include an enclosure assembly that houses the battery cells. During a thermal event, one or more of the battery cells may vent and discharge vent byproducts into an interior area of the enclosure.

### SUMMARY

In some aspects, the techniques described herein relate to a traction battery pack assembly, including: an enclosure assembly configured to house a plurality of battery cells within an interior area, the enclosure assembly at least partially provided by a multilayer structure having an apertured core with one or more layers sandwiched between an outer shell and an inner shell, the apertured core having a plurality of apertures, the multilayer structure at least partially impregnated with a resin.

In some aspects, the techniques described herein relate to a traction battery pack assembly, wherein the resin at least partially fills the plurality of apertures of the apertured core.

In some aspects, the techniques described herein relate to a traction battery pack assembly, wherein the plurality of apertures open to the outer shell and open to the inner shell.

In some aspects, the techniques described herein relate to a traction battery pack assembly, wherein the enclosure assembly is an enclosure cover.

In some aspects, the techniques described herein relate to a traction battery pack assembly, wherein the inner shell is secured to a thermal barrier within the interior area, the thermal barrier disposed between two battery cells within the plurality of battery cells.

In some aspects, the techniques described herein relate to a traction battery pack assembly, wherein the resin is a spray-transfer molded resin.

In some aspects, the techniques described herein relate to a traction battery pack assembly, wherein the resin is a polyurethane spray resin.

In some aspects, the techniques described herein relate to a traction battery pack assembly, wherein the resin bonds the inner shell to the apertured core, and bonds the outer shell to the apertured core.

In some aspects, the techniques described herein relate to a traction battery pack assembly, wherein the outer shell includes at least one glass fiber layer, and the inner shell includes at least one other glass fiber layer.

In some aspects, the techniques described herein relate to a traction battery pack assembly, wherein the inner shell includes a woven e-glass layer and a randomly chopped glass layer.

In some aspects, the techniques described herein relate to a traction battery pack assembly, wherein the apertured core includes one or more mesh layers.

In some aspects, the techniques described herein relate to a traction battery pack assembly, wherein the one or more mesh layers are steel mesh layers.

In some aspects, the techniques described herein relate to a traction battery pack assembly, wherein the apertured core includes at least one aramid honeycomb mesh layer.

In some aspects, the techniques described herein relate to a traction battery pack assembly, wherein the apertured core further includes an inner steel mesh layer and an outer steel mesh layer sandwiching the at least one aramid honeycomb mesh layer.

In some aspects, the techniques described herein relate to a traction battery pack assembly, wherein the outer shell includes a metallic layer.

In some aspects, the techniques described herein relate to a method of making a battery pack enclosure, including: sandwiching an apertured core between an outer shell and an inner shell to provide a multilayer structure; and impregnating at least a portion of the multilayer structure with a resin.

In some aspects, the techniques described herein relate to a method, wherein the resin at least partially fills a plurality of apertures of the apertured core after the impregnating.

In some aspects, the techniques described herein relate to a method, further including impregnating the multilayer structure using spray transfer molding.

In some aspects, the techniques described herein relate to a method, further including impregnating the multilayer structure using liquid compression molding.

In some aspects, the techniques described herein relate to a method, further including bonding the apertured core to both the outer shell and the inner shell with the resin.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a section view taken at line 3-3 in FIG. 2 when the battery pack is assembled.

FIG. 4 schematically illustrates a closeup view of an area of the section of FIG. 3 showing a cover of an enclosure assembly prior to impregnation with a resin.

FIG. 5 schematically illustrates the section view of FIG. 4 after impregnation with the resin.

FIG. 6 schematically illustrates a section view of a portion of an enclosure cover according to another exemplary embodiment.

FIG. 7 schematically illustrates a section view a portion of an enclosure cover according to yet another exemplary embodiment of the present disclosure.

FIG. 8 schematically illustrates a section view a portion of an enclosure cover according to yet another exemplary embodiment of the present disclosure.

FIG. 9 schematically illustrates a section view a portion of an enclosure cover according to yet another exemplary embodiment of the present disclosure.

FIG. 10 schematically illustrates a section view a portion of an enclosure cover according to yet another exemplary embodiment of the present disclosure.

FIG. 11 schematically illustrates a section view a portion of an enclosure cover according to yet another exemplary embodiment of the present disclosure.

FIG. 12 schematically illustrates a section view a portion of an enclosure cover according to yet another exemplary embodiment of the present disclosure.

FIG. 13 schematically illustrates a section view a portion of an enclosure cover according to yet another exemplary embodiment of the present disclosure.

FIG. 14 schematically illustrates a section view a portion of an enclosure cover according to yet another exemplary embodiment of the present disclosure.

FIG. 15 schematically illustrates a section view a portion of an enclosure cover according to yet another exemplary embodiment of the present disclosure.

FIG. 16 schematically illustrates a section view a portion of an enclosure cover according to yet another exemplary embodiment of the present disclosure.

### DETAILED DESCRIPTION

This disclosure details enclosures for a traction battery pack.

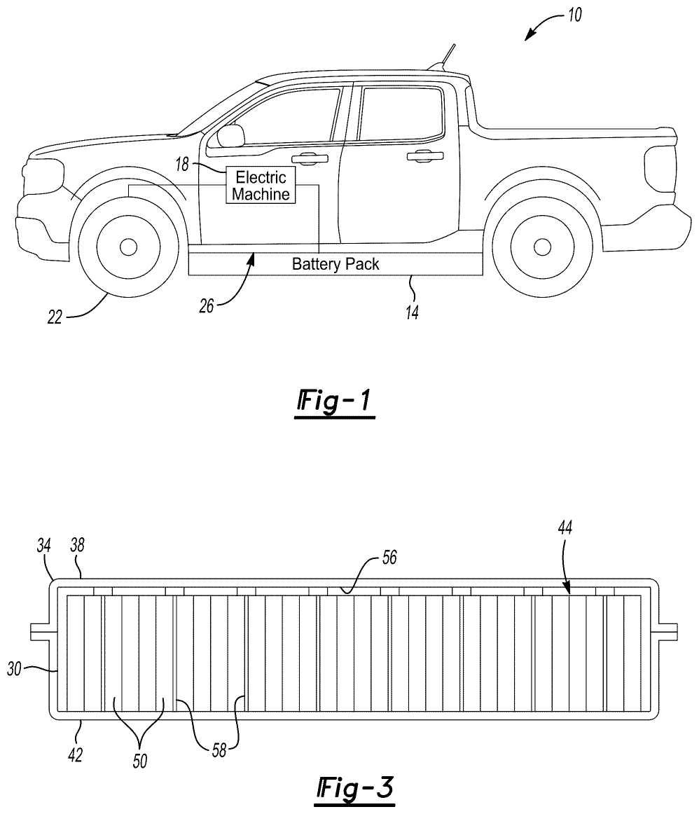

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

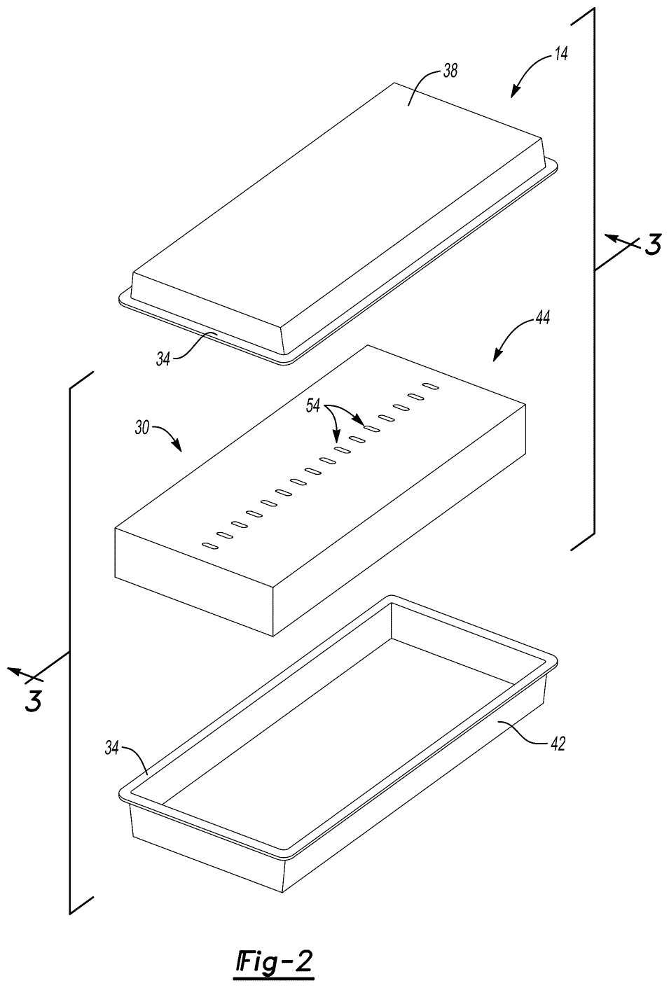

With reference now to FIGS. 2 and 3, the battery pack 14 includes at least one battery array 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the battery arrays 30. The enclosure cover 38 can be secured to the enclosure tray 42 using mechanical fasteners (not shown), for example.

Each of the battery arrays 30 includes, among other things, a plurality of battery cells 50 (or simply “cells”) stacked side-by-side relative to each along a respective battery array axis. The battery cells 50 store and supply electrical power. Although a specific number of the battery arrays 30 and cells 50 are illustrated in the various figures of this disclosure, the battery pack 14 could include any number of the battery arrays 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

From time to time, pressure and thermal energy within one or more of the battery cells 50 in the battery pack 14 can increase. This may lead to the battery cells 50 expelling vent byproducts, which can include gas and debris.

The vent byproducts can be expelled from the associated battery cell 50 through a designated vent 54 within the housing of the battery cell 50, such as a membrane that yields in response to increased pressure, or through a ruptured area of the associated battery cell 50. In this example, the battery cells 50 are configured to vent vertically upwards toward an underside 56 of the enclosure cover 38. Vertical is with reference to ground and an orientation of the battery pack 14 when installed in the vehicle 10.

When assembled, the enclosure cover 38 can be bonded to a plurality of thermal barriers 58 each disposed between the battery cells 50 of the battery array 30 housed within the interior area 44.

In this example, a structural adhesive 60 bonds the thermal barriers 58 to the enclosure cover 38. Bonding the thermal barriers 58 to the enclosure cover 38 can help to compartmentalize regions within the interior area 44 thereby confining vent byproducts and preventing those vent products from causing other battery cells 50 that are not venting to start venting.

The exemplary enclosure assembly 34, and particularly the enclosure cover 38, includes features designed to withstand the vent byproducts. Although the example embodiments of this disclosure are described in connection with the enclosure cover 38, the teachings of this disclosure could be utilized in connection with any area of the enclosure assembly 34 including, for example, the enclosure tray 42, a mid-plate enclosure, or perhaps a region of the enclosure cover 38 or the enclosure tray 42. The mid-plate enclosure could, for example, enclose some of the battery cells 50 within the larger enclosure assembly 34. The features can be incorporated into the entire enclosure cover 38 or enclosure tray 42, or a region of the enclosure assembly 34, such as a region facing the vents 54 of the battery cells 50.

With reference now to FIGS. 4 and 5, and continuing reference to FIGS. 2 and 3, the example enclosure cover 38 includes a multilayer structure 70. In the exemplary embodiment, the multilayer structure 70 includes an apertured core 74, an outer shell 78, and an inner shell 82. Outer and inner is with reference to the interior area 44 of the enclosure assembly 34.

The outer shell 78 are, in this example, each a randomly chopped glass fiber layer 86 that is about 450 grams per square meter (GSM).

The inner shell 82 is, in this example, also the randomly chopped glass fiber layer 86 with each of the three randomly chopped glass fiber layers being about 450 GSM. The apertured core 74 are each a steel mesh layer 88 in this example. The two steel mesh layers 88 are each about 100 microns thick. As the apertured core 74 are mesh, the inner shell include a plurality of apertures, which open to both the outer shell 78 and the inner shell 82.

The apertured core 74, the outer shell 78, and the inner shell 82 establishing the multilayer structure 70 are impregnated with a resin 80, which can be a polyurethane resin. The resin 80 cures to help hold together the multilayer structure 70. The resin 80 can partially or fully impregnate the multilayer structure 70. Impregnating the multilayer structure 70 at least partially fills the apertures of apertured core 74, here the apertures of the steel mesh layer 88.

In the exemplary embodiment, the apertured core 74, the outer shell 78, and the inner shell 82 are arranged as shown in FIG. 4 within a die. The resin 80 is a spray resin that is then applied to the multilayer structure 70 utilizing a spray-transfer molding process. The resin 80 impregnating the multilayer structure 170 can be a polyurethane spray resin that is 900 GSM.

A person having skill in this art and the benefit of this disclosure would be able to structurally distinguish a spray-transfer molded resin of a component from a component that does not include a spray-transfer molded resin. Thus, specifying that the material of the multilayer structure 70 is a spray-transfer molded resin is a structural limitation.

Impregnating the apertured core 74, the outer shell 78, and the inner shell 82 with the resin 80 bonds together the apertured core 74, the outer shell 78, and the inner shell 82 to provide the enclosure cover 38. The apertured core 74, due to the apertures, can communicate resin through the apertured core 74 during the bonding process.

Although the example resin is introduced to the multilayer structure 70 utilizing spray-transfer molding, other ways of introducing the resin could be utilized in other examples. For example, the resin 80 could be introduced through a liquid compression molding technique.

The resin 80 provides a coating and bonds together the various layers of the multilayer structure 70. The outer shell 78 can provide thermal resistance and insulation, as can the inner shell 82. The steel mesh layers 88 of the apertured core 74 can provide structural integrity to the enclosure cover 38 help to withstand a stream of vent byproducts impinging off an underside of the enclosure cover 38 and can facilitate transfer of thermal energy.

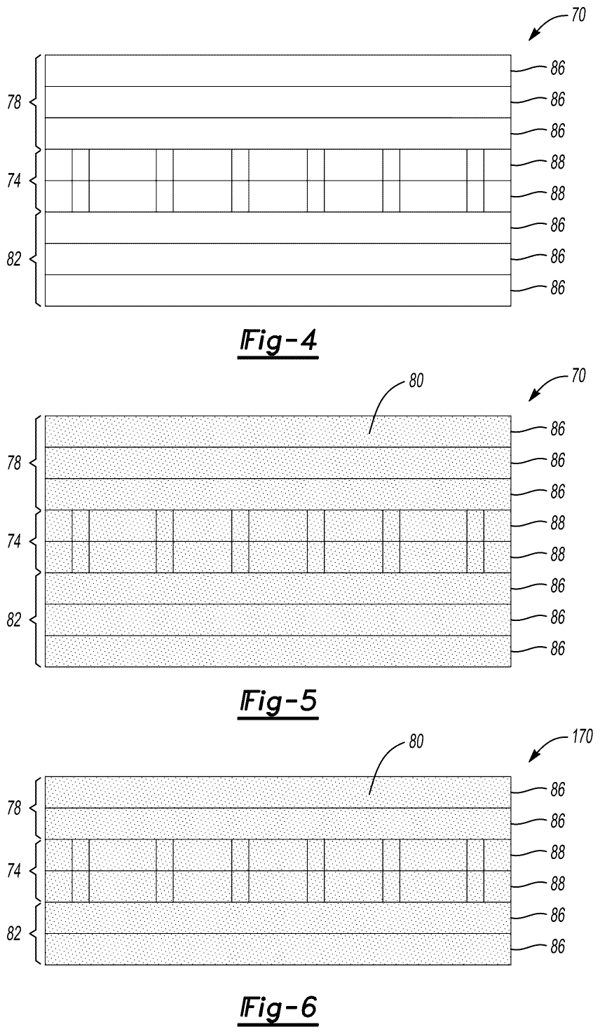

With reference now to FIG. 6, another example multilayer structure 170 is impregnated with the resin 80. The apertured core 74 of the multilayer structure 170 is provided by two of the steel mesh layers 88. The outer shell 78 of the multilayer structure 170 is provided by two of the randomly chopped glass fiber layers 86. The inner shell 82 of the multilayer structure 170 is also provided by two of the randomly chopped glass fiber layers 86.

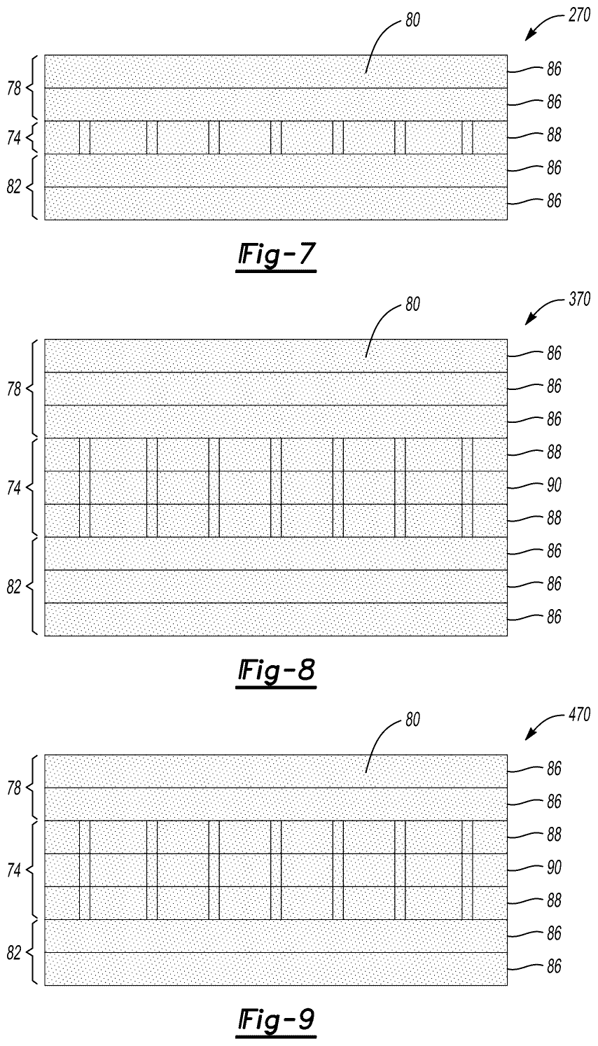

Next, with reference to FIG. 7, another example multilayer structure 270 is impregnated with the resin 80. The apertured core 74 of the multilayer structure 270 is provided by one of the steel mesh layers 88. The outer shell 78 is provided by two of the randomly chopped glass fiber layers 86, and the inner shell 82 provided by two of the randomly chopped glass fiber layers 86.

With reference to FIG. 8, another example multilayer structure 370 is impregnated with resin 80. The apertured core 74 of the multilayer structure 370 is provided by an aramid honeycomb layer 90 sandwiched between two of the steel mesh layers 88. The outer shell 78 and the inner shell 82 are each provided by three of the randomly chopped glass fiber layers 86.

With reference to FIG. 9, another multilayer structure 470 is impregnated with resin 80. The apertured core 74 of the multilayer structure 370 is provided by the aramid honeycomb layer 90 sandwiched between two steel mesh layers 88. The outer shell 78 and the inner shell 82 are each provided by two layers of the randomly chopped glass fiber 86.

With reference to FIG. 10, another multilayer structure 570 is impregnated with the resin 80. The apertured core 74 of the multilayer structure 570 is provided by two of the aramid honeycomb layers 90, which can be each be about 1.5 millimeters thick for example. The apertured core 74 of the multilayer structure 570 is sandwiched between the outer shell 78 provided by three of the randomly chopped glass fiber layers 86, and the inner shell 82 provided by three of the randomly chopped glass fiber layers 86.

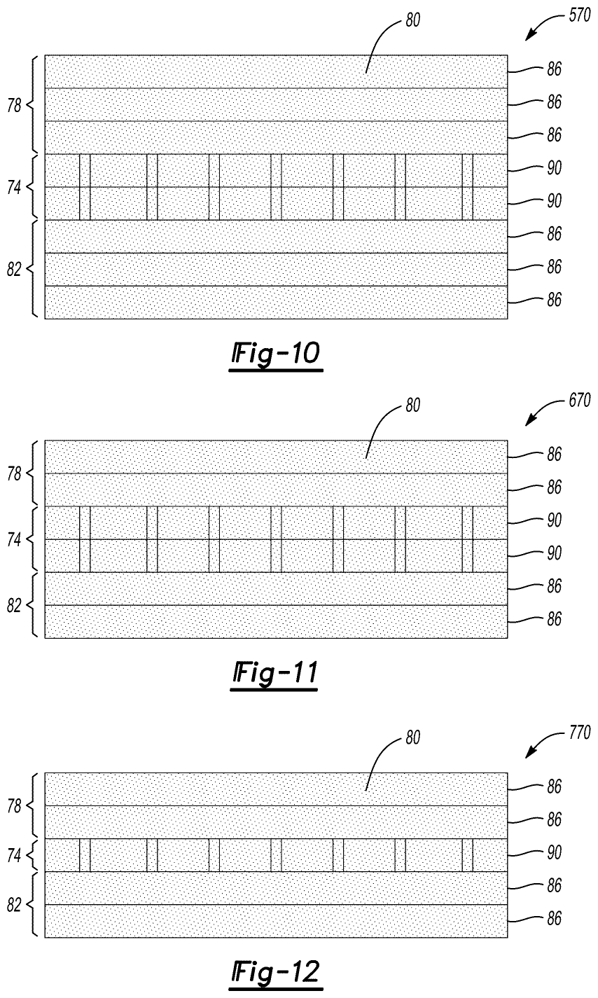

With reference to FIG. 11, another exemplary multilayer structure 670 is impregnated with the resin 80. The apertured core 74 of the multilayer structure 670 is provided by two of the aramid honeycomb layers 90. The apertured core 74 of the multilayer structure 670 is sandwiched between the outer shell 78 provided by two of the randomly chopped glass fiber layers 86, and the inner shell 82 provided by two of the randomly chopped glass fiber layers 86.

With reference to FIG. 12, another exemplary multilayer structure 770 is impregnated with the resin 80. The multilayer structure 770 is similar to the multilayer structure 670 of the FIG. 11 embodiment, but the apertured core 74 is provided by one of the aramid honeycomb layers 90. The apertured core 74 is sandwiched between two of the randomly chopped glass fiber layers that provide the outer shell 78 and two of the randomly chopped glass fiber layers that provide the inner shell 82.

With reference to FIG. 13, another exemplary multilayer structure 870 includes some layers that are impregnated with the resin 80 and one layer that is not impregnated with the resin 80. The apertured core 74 of the multilayer structure 870 is provided by two of the steel mesh layers 88. The outer shell 78 of the multilayer structure 870 is provided by one of the randomly chopped glass fiber layers 86, and a metallic layer 94, which can be a metal or metal alloy. The metallic layer is an e-coated steel material in some examples. The inner shell 82 is provided by two of the randomly chopped glass fiber layers 86. The randomly chopped glass fiber layers 86 and the steel mesh layers 88 can be impregnated with the resin 80, and then bonded to the layer 94.

With reference now to FIG. 14, another exemplary multilayer structure 970 includes some layers that are impregnated with the resin 80 and one layer that is not impregnated with the resin 80. The apertured core 74 of the multilayer structure 970 is provided by two of the steel mesh layers 88. One of the steel mesh layers 88 is about half a thickness of the other steel mesh layer 88. In an example, one of the steel mesh layers 88 is about 50 microns thick and the other of the steel mesh layers is about 100 microns thick. The outer shell 78 of the multilayer structure 970 is provided by one of the randomly chopped glass fiber layers 86, and a metal or metal-alloy layer 94, which can be an e-coated steel material. The inner shell 82 is provided by two of the randomly chopped glass fiber layers 86. The randomly chopped glass fiber layers 86 and the steel mesh layers 88 can be impregnated with the resin 80, and then bonded to the layer 94.

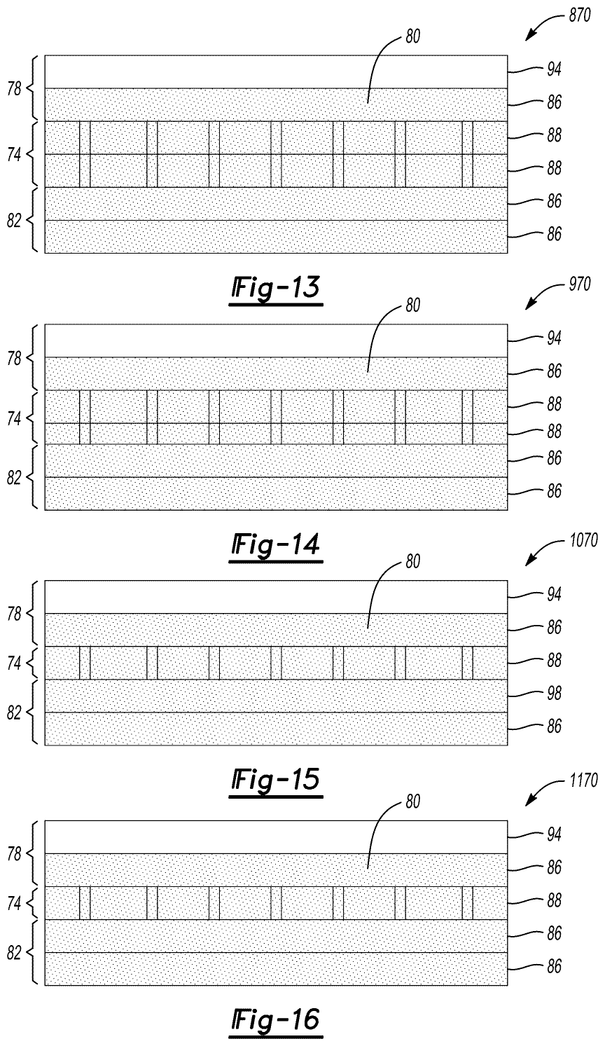

With reference now to FIG. 15, yet another exemplary multilayer structure 1070 includes some layers that are impregnated with the resin 80 and one layer that is not impregnated with the resin 80. The apertured core 74 of the multilayer structure is provided by one of the steel mesh layers 88. The outer shell 78 of the multilayer structure 1070 is provided by one of the randomly chopped glass fiber layers 86, and the metal or metal-alloy layer 94, which can be an e-coated steel material. The inner shell 82 is provided by one of the randomly chopped glass fiber layers 86, and a woven e-glass layer 98, which can be 450 GSM.

With reference now to FIG. 16, yet another exemplary multilayer structure 1170 includes some layers that are impregnated with the resin 80 and one layer that is not impregnated with the resin 80. The apertured core 74 of the multilayer structure 1170 is provided by one of the steel mesh layers 88. The outer shell 78 of the multilayer structure 1170 is provided by one of the randomly chopped glass fiber layers 86, and the metal or metal-alloy layer 94, which can be an e-coated steel material. The inner shell 82 is provided by two of the randomly chopped glass fiber layers 86.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly configured to house a plurality of battery cells within an interior area, the enclosure assembly at least partially provided by a multilayer structure having an apertured core with one or more layers sandwiched between an outer shell and an inner shell, the apertured core having a plurality of apertures, the multilayer structure at least partially impregnated with a resin.

2. The traction battery pack assembly of claim 1, wherein the resin at least partially fills the plurality of apertures of the apertured core.

3. The traction battery pack assembly of claim 1, wherein the plurality of apertures open to the outer shell and open to the inner shell.

4. The traction battery pack assembly of claim 1, wherein the enclosure assembly is an enclosure cover.

5. The traction battery pack assembly of claim 1, wherein the inner shell is secured to a thermal barrier within the interior area, the thermal barrier disposed between two battery cells within the plurality of battery cells.

6. The traction battery pack assembly of claim 1, wherein the resin is a spray-transfer molded resin.

7. The traction battery pack assembly of claim 1, wherein the resin is a polyurethane spray resin.

8. The traction battery pack assembly of claim 1, wherein the resin bonds the inner shell to the apertured core, and bonds the outer shell to the apertured core.

9. The traction battery pack assembly of claim 1, wherein the outer shell comprises at least one glass fiber layer, and the inner shell comprises at least one other glass fiber layer.

10. The traction battery pack assembly of claim 1, wherein the inner shell comprises a woven e-glass layer and a randomly chopped glass layer.

11. The traction battery pack assembly of claim 1, wherein the apertured core comprises one or more mesh layers.

12. The traction battery pack assembly of claim 11, wherein the one or more mesh layers are steel mesh layers.

13. The traction battery pack assembly of claim 1, wherein the apertured core comprises at least one aramid honeycomb mesh layer.

14. The traction battery pack assembly of claim 13, wherein the apertured core further comprises an inner steel mesh layer and an outer steel mesh layer sandwiching the at least one aramid honeycomb mesh layer.

15. The traction battery pack assembly of claim 1, wherein the outer shell comprises a metallic layer.

16. A method of making a battery pack enclosure, comprising:
sandwiching an apertured core between an outer shell and an inner shell to provide a multilayer structure; and
impregnating at least a portion of the multilayer structure with a resin.

17. The method of claim 16, wherein the resin at least partially fills a plurality of apertures of the apertured core after the impregnating.

18. The method of claim 16, further comprising impregnating the multilayer structure using spray transfer molding.

19. The method of claim 16, further comprising impregnating the multilayer structure using liquid compression molding.

20. The method of claim 16, further comprising bonding the apertured core to both the outer shell and the inner shell with the resin.
